(19) United States
(12) Patent Application Publication
(10) Pub. No.: US 2013/0344410 A1
(43) Pub. Date: Dec. 26, 2013

(54) SYSTEM AND METHOD FOR OPERATING FUEL CELL SYSTEM

(71) Applicant: HYUNDAI MOTOR COMPANY, Seoul (KR)

(72) Inventors: Ik Jae Son, Yongin (KR); Bong Hyun Park, Hwaseong (KR)

(73) Assignee: Hyundai Motor Company, Seoul (KR)

(21) Appl. No.: 13/682,031

(22) Filed: Nov. 20, 2012

(30) Foreign Application Priority Data
Jun. 20, 2012 (KR) 10-2012-0065889

(51) Int. Cl. H01M 8/04

(52) U.S. Cl. CPC H01M 8/04231
USPC 429/429

(57) ABSTRACT

Disclosed is a system and method for operating a fuel cell system, which improves durability of a fuel cell stack by purging oxygen diffusing into an air electrode of the fuel cell stack while the fuel cell vehicle is parking. That is, the present invention provides a system and method for operating a fuel cell system, which prevents an interface between oxygen and hydrogen from forming at an anode by periodically supplying hydrogen to a cathode to purge oxygen when the oxygen concentration is greater than a predetermined level to prevent oxygen in the air from diffusing into the cathode while parking the fuel cell vehicle, thus preventing durability of a membrane electrode assembly of a fuel cell stack from deteriorating.

### CROSS-REFERENCE TO RELATED APPLICATION

This application claims under 35 U.S.C. §119(a) the benefit of Korean Patent Application No. 10-2012-0065889 filed Jun. 20, 2012, the entire contents of which are incorporated herein by reference.

### BACKGROUND

(a) Technical Field

The present invention relates to a system and method for operating a fuel cell system. More particularly, it relates to a system and method for operating a fuel cell system, which improves durability of a fuel cell stack by purging oxygen diffusing into an air electrode of the fuel cell stack during parking of a fuel cell vehicle.

### (b) Background Art

Many automobile companies have begun developing hydrogen fuel cell vehicles interesting an effort to develop environmentally friendly vehicles which provide an alternative to gas engine vehicles. A fuel cell system applied to a hydrogen fuel cell vehicle generally includes a fuel cell stack configured to generate electricity by electrochemical reaction, a hydrogen supply system configured to supply hydrogen as a fuel to the fuel cell stack, an oxygen (air) supply system configured to supply oxygen-containing air as an oxidant required for the electrochemical reaction in the fuel cell stack, a thermal management system (TMS configured to remove reaction heat from the fuel cell stack to the outside of the fuel cell system, control operation temperatures of the fuel cell stack, and perform water management functions, and a system controller configured to control overall operation of the fuel cell system.

The fuel cell stack is a form of power generation device which generates electricity as the main energy source of the fuel cell vehicle and has a structure in which a fuel electrode to which hydrogen is supplied and an air electrode to which air is supplied are stacked on both sides of a membrane electrode assembly (MEA) so that oxygen in air electrochemically reacts with externally supplied hydrogen to generate electrical energy.

Accordingly, during operation of the fuel cell system, hydrogen with a high degree of purity is supplied to the fuel electrode (“anode”) and, at the same time, oxygen from the air is directly supplied to the air electrode (“cathode”) by the air supply system, e.g., an air blower, to generate electrical energy.

The hydrogen supplied to the fuel cell stack is dissociated into hydrogen ions and electrons by a catalyst of the anode. The dissociated hydrogen ions are transmitted to the cathode through an electrolyte membrane and, at the same time, the oxygen supplied to the cathode combines with the electrons transmitted through an external conduction wire, thus generating electrical energy with water as a by-product. The generated electrical energy is used to power a drive motor, and thus the fuel cell vehicle equipped with the fuel cell stack can be driven accordingly.

After operation of the fuel cell vehicle, an interface between hydrogen and oxygen is formed at the anode by oxygen diffusing into the cathode of the fuel cell stack while the vehicle is parked and, at the same time, a potential retention time is prolonged. This, phenomenon deteriorates the durability of the membrane electrode assembly, however.

One method of reducing the likelihood of this deterioration phenomenon is described in, U.S. Pat. No. 6,887,599, which discloses a method for starting up a fuel cell system during a fuel purge, in which air is supplied to a cathode after eliminating the interface between hydrogen and oxygen formed at an anode, supplies hydrogen to the anode during start-up of a fuel cell vehicle. However, in the above patent, a retention time for eliminating the interface between hydrogen and oxygen at the anode is required during startup.

Furthermore, U.S. Patent Application Publication No. 20060046106 discloses a method of using a H₂ purge for stack startup/shutdown to improve stack durability, in which during startup and shutdown of a fuel cell vehicle, hydrogen gas is introduced into an anode and a cathode at the same time to purge oxygen and eliminate the interface between hydrogen and oxygen formed at the anode. However, the above method supplies only hydrogen gas to the anode and the cathode to purge oxygen during startup and shutdown of the vehicle. Furthermore, the interface between hydrogen and oxygen is formed at the anode by oxygen diffusing into the cathode while the fuel cell vehicle is parked and, at the same time, the potential retention time is prolonged, thus deteriorating the durability of the fuel cell stack.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

Systems and methods for operating a fuel cell system are provided, which prevent an interface between oxygen and hydrogen from being formed at an anode by periodically supplying hydrogen to a cathode to purge oxygen when the oxygen concentration is greater than a predetermined level to prevent oxygen in the air from diffusing into the cathode while the fuel cell vehicle is parked, thus preventing the durability of a membrane electrode assembly of a fuel cell stack from deteriorating.

In one aspect, the exemplary embodiment of the present invention provides a system and method for operating a fuel cell system. In particular, a hydrogen purge cycle of a cathode is identified based on an oxygen concentration according to the amount of time that the fuel cell vehicle remains parked after being shutdown; and purging oxygen from the cathode by supplying hydrogen to the cathode at each identified hydrogen purge cycle.

In the exemplary embodiment, the hydrogen purge cycle may be determined as the amount of time it takes for the oxygen concentration in/at the cathode to exceed a predetermined oxygen concentration threshold as the parking time increases.

In another exemplary embodiment, the oxygen concentration threshold may be determined as the oxygen concentration at a point in time when an open circuit voltage for each oxygen concentration of the fuel cell stack, which is monitored after forcibly introducing oxygen into the cathode, increases to a predetermined value. The oxygen concentration may also be measured by an oxygen sensor mounted on the cathode.

In yet another exemplary embodiment, the system and method may further include supplying hydrogen and air to an anode and the cathode at the same time without any amount of time at which a high potential is retained during startup after parking of the fuel cell vehicle.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a graph showing exemplary measurement results of the oxygen concentration at a cathode according to the amount of time a vehicle remains parked in accordance with an exemplary embodiment of the present invention;

FIG. 2 is a graph showing exemplary measurement results of cell voltage according to oxygen concentration at a cathode in accordance with an exemplary embodiment of the present invention; and

FIG. 3 is a graph showing exemplary measurement results of stack voltage behavior according to oxygen concentration at a cathode during startup after a fuel cell vehicle has been parked in accordance with an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The below exemplary method and system may be operated by a controller configured to perform the below process. It is understood, however that the below processes may also be performed by a plurality of controllers executing processors thereon.

Furthermore, the control logic calculating the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The present invention is characterized in that hydrogen purge is periodically performed by detecting a change in oxygen concentration according to the amount of time a fuel cell vehicle has remained parked to prevent an interface between oxygen and hydrogen from being formed at an anode by oxygen in air diffusing into a cathode while the fuel cell vehicle is parked.

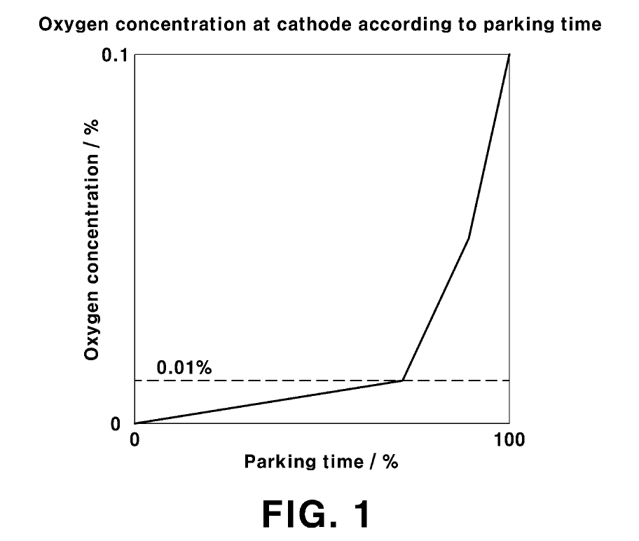

More specifically, in the exemplary embodiment of the present invention, the oxygen concentration at the cathode of a fuel cell stack is measure according to the amount of time the fuel cell vehicle has remained parked after the vehicle has been initially shutdown. Preferably, the oxygen concentration at the cathode may be measured by mounting an oxygen sensor directly on the cathode, or otherwise may be calculated using a typical calculation method based on actual measurement values associated with surrounding environmental factors (such as outdoor temperature, altitude, outdoor relative humidity, etc.). After measuring the oxygen concentration at the cathode according to the amount of time the fuel cell vehicle has remained parked, a hydrogen purge cycle of the cathode may be determined based on the measurement results, and an example thereof is shown in FIG. 1.

FIG. 1 is a graph illustrating a change in oxygen concentration at the cathode in relation to the amount of time the fuel cell vehicle remains parked, from which it can be seen that oxygen from external air increasingly diffuses into the cathode as the parking time increases. According to the illustrative embodiment of the present invention, the hydrogen purge cycle may be determined based on the measured data showing the change in oxygen concentration at the cathode according to the parking time. Preferably, the extent to which the oxygen diffuses into the cathode does not affect the durability of a membrane electrode assembly in the illustrative embodiment of the present invention. Thus, it is preferable that the hydrogen purge cycle is identified to be at the point in time when the oxygen concentration exceeds a predetermined threshold of, e.g., 0.01%.

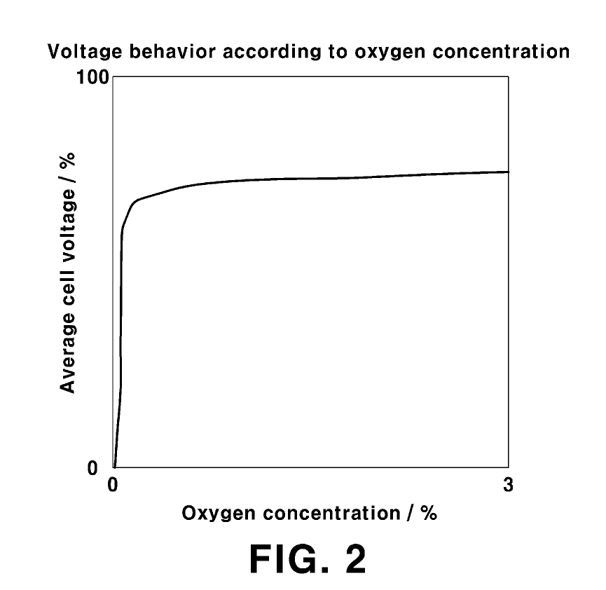

More preferably, as shown in FIG. 2, as a system and method for determining the oxygen concentration threshold, the open circuit voltage (OCV) for each oxygen concentration of the fuel cell stack may be monitored after forcibly introducing oxygen into the cathode, and the oxygen concentration at the time when the monitored open circuit voltage increases to a predetermined value may be determined as the oxygen concentration threshold. Here, when the open circuit voltage is greater than the predetermined value this means that the oxygen concentration is at a level at which the oxygen diffusing into the cathode while the vehicle is parked is reacting with hydrogen remaining in the anode to generate a fairly high potential, and thus the membrane electrode assembly is being corroded by the high potential as a result. Thus, it is preferable that the open circuit voltage be maintained below the predetermined value. Accordingly, through the above-described process, the oxygen concentration at the time when the open circuit voltage increases to the predetermined value is determined as the oxygen concentration threshold.

Once the hydrogen purge cycle has been determined, preferably in the above manner, oxygen is automatically purged from the cathode to the outside by periodically supplying hydrogen to the cathode at each hydrogen purge cycle. Thus, when the concentration of oxygen in air diffusing into the cathode is greater than the above oxygen concentration threshold, hydrogen is supplied to the cathode to purge the oxygen in and around cathode so that the formation of an interface between hydrogen and oxygen at the anode can be prevented while the vehicle is parked, thus effectively preventing the durability of the fuel cell stack from deteriorating due to the corrosion of the membrane electrode assembly.

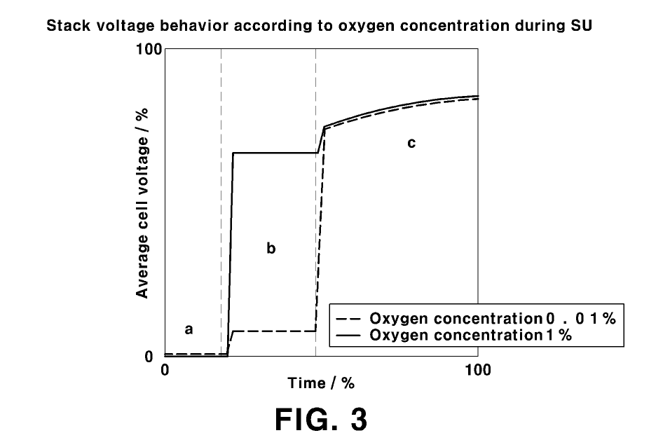

FIG. 3 is a graph illustrating exemplary measurement results of stack voltage behavior according to the oxygen concentration at the cathode during startup after a vehicle has been parked, in which the dashed line represents that the oxygen concentration is maintained below the threshold (0.01%) by the hydrogen purge of the cathode during parking, and the solid line represents that the oxygen concentration is maintained above the threshold (0.01%). In FIG. 3, section (a) represents the initial startup after parking of the fuel cell vehicle, section (b) represents the hydrogen purge at which hydrogen and air are supplied to the anode and the cathode at the same time, and section (c) represents the completion of the startup. Furthermore, the area of (c) in FIG. 3 represents a range of maximum stack voltage output by a fuel cell at 21% of oxygen concentration as oxygen is supplied normally at start up; the voltage output within the area (b) varies depending on the oxygen concentration at cathode; and the voltage for (a) (i.e., ‘100% in Y axis’) represents the maximum theoretical stack voltage.

Referring to FIG. 3, when the oxygen concentration is maintained at or above the threshold (0.01%), the interface between hydrogen and oxygen is formed at the anode, to which the oxygen diffusing into the cathode is transmitted, before startup of the vehicle is completed, and thus a high potential, e.g., 70%-80% of the open circuit voltage with 21% oxygen content, is generated as shown by the solid line in section (b). As a result, the amount of time that high potential is present is prolonged, and thus the durability of the fuel cell stack may deteriorate.

For reference, the electrochemical reaction occurring due to the oxygen in the cathode of the fuel cell stack during startup and shutdown of the fuel cell vehicle and the open circuit voltage generated thereby cause corrosion of catalyst-loaded carbon in the fuel cell stack and deterioration of the durability of the fuel cell stack. Therefore, to solve these problems, a cathode oxygen depletion (COD), which is a type of resistor included in a COD heater, is connected to both terminals of the fuel cells stack to eliminate the open circuit voltage.

On the contrary, when the oxygen concentration is maintained below the threshold (0.01%), the interface between hydrogen and oxygen is not formed, and thus the high potential is not generated as shown by the dashed line in section (b). As a result, it is possible to supply oxygen and air to the anode and the cathode, respectively, without any high potential retention time, and thus it is possible to prevent the durability of the fuel cell stack from deteriorating due to the high potential.

As described above, the present invention provides the following effects.

It is possible to prevent the formation of the interface between hydrogen and oxygen at the anode by periodically supplying hydrogen to the cathode to purge oxygen when the oxygen concentration at the cathode according to the parking time is measured and the measured oxygen concentration is greater than an oxygen concentration threshold. Thus, it is possible to prevent the durability of the fuel cell stack from deteriorating due to the corrosion of the membrane electrode assembly caused by the interface between hydrogen and oxygen, thereby improving the durability of the fuel cell stack.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method for operating a fuel cell system, the method comprising:
identifying, a controller, a hydrogen purge cycle of a cathode based on an oxygen concentration measuring in relation an amount of time a fuel cell vehicle has remained parked after shutdown; and
purging oxygen from the cathode by supplying hydrogen to the cathode at an end of each hydrogen purge cycle.

2. The method of claim 1, wherein the hydrogen purge cycle is a time at which the oxygen concentration at the cathode exceeds a predetermined oxygen concentration threshold.

3. The method of claim 2, wherein the oxygen concentration threshold is determined as the oxygen concentration at a time when an open circuit voltage for each oxygen concentration of the fuel cell stack, which is monitored after forcibly introducing oxygen into the cathode, reaches a predetermined value.

4. The method of claim 1, wherein the oxygen concentration is measured by an oxygen sensor mounted on the cathode.

5. The method of claim 1, further comprising supplying hydrogen and air to an anode and the cathode at the same time without a potential exceeding a predetermined value for any amount of time during startup after the fuel cell vehicle has been parked.

6. A system for operating a fuel cell system, the method comprising:
a controller configured to identify a hydrogen purge cycle of a cathode based on an oxygen concentration measuring in relation an amount of time a fuel cell vehicle has remained parked after shutdown, and purge oxygen from the cathode by controlling the supply of hydrogen to the cathode at each hydrogen purge cycle.

7. The system of claim 6, wherein the hydrogen purge cycle is a time at which the oxygen concentration at the cathode exceeds a predetermined oxygen concentration threshold.

8. The system of claim 7, wherein the oxygen concentration threshold is determined as the oxygen concentration at a time when an open circuit voltage for each oxygen concentration of the fuel cell stack, which is monitored after forcibly introducing oxygen into the cathode, reaches a predetermined value.

9. The system of claim 6, wherein the controller is further configured to control the supply hydrogen and air to an anode and the cathode at the same time without a potential exceeding a predetermined value for any amount of time during startup after the fuel cell vehicle has been parked.

10. A non-transitory computer readable medium containing program instructions executed by a controller for operating a fuel cell system, the computer readable medium comprising:
program instructions that identify a hydrogen purge cycle of a cathode based on an oxygen concentration measuring in relation an amount of time a fuel cell vehicle has remained parked after shutdown; and
program instructions that control the purge of oxygen from the cathode by supplying hydrogen to the cathode at each hydrogen purge cycle.

11. The non-transitory computer readable medium of claim 10, wherein the hydrogen purge cycle is a time at which the oxygen concentration at the cathode exceeds a predetermined oxygen concentration threshold.

12. The non-transitory computer readable medium of claim 11, wherein the oxygen concentration threshold is determined as the oxygen concentration at a time when an open circuit voltage for each oxygen concentration of the fuel cell stack, which is monitored after forcibly introducing oxygen into the cathode, reaches a predetermined value.

13. The non-transitory computer readable medium of claim 11, further comprising program instructions that supply hydrogen and air to an anode and the cathode at the same time without a potential exceeding a predetermined value for any amount of time during startup after the fuel cell vehicle has been parked.
